(19) United States
(12) Patent Application Publication
(10) Pub. No.: US 2026/0270387 A1
(43) Pub. Date: Sep. 10, 2026

(54) CONTROL METHOD AND CONTROL DEVICE FOR HEAD-MOUNTED DISPLAY APPARATUS, ELECTRONIC APPARATUS AND STORAGE MEDIUM

(71) Applicant: GOERTEK TECHNOLOGY CO., LTD, Qingdao, Shandong (CN)

(72) Inventor: Qiang CHEN, Qingdao, Shandong (CN)

(21) Appl. No.: 18/994,898

(22) PCT Filed: Sep. 28, 2023
(86) PCT No.: PCT/CN2023/122467

§ 371 Date: Jan. 15, 2025

(30) Foreign Application Priority Data
Sep. 29, 2022 (CN) 202211200124.5

(51) Int. Cl. H04N 13/398; G01S 5/00; H04N 13/324

(52) U.S. Cl. CPC H04N 13/398; G01S 5/017; H04N 13/324

(57) ABSTRACT

A control method and a control device for a head-mounted display apparatus, an electronic apparatus and a computer-readable storage medium are disclosed, which relate to a technical field of head-mounted display apparatuses. The method comprises: obtaining distance information between the head-mounted display apparatus and a target apparatus, wherein the head-mounted display apparatus is wirelessly connected to the target apparatus; detecting an interaction behavior between the head-mounted display apparatus and the target apparatus according to the distance information; adjusting a color of a light-shielding sheet of the head-mounted display apparatus according to the interaction behavior. Thus, the color of the light-shielding sheet of the head-mounted display apparatus can be adjusted according to the interaction behavior to achieve the interactive control of the apparatus status, thereby triggering an automatic color change of the light-shielding sheet of the head-mounted display apparatuses by the interaction between the apparatuses, and improving the user's experience.

This application claims a priority to a Chinese patent application No. 202211200124.5, entitled “CONTROL METHOD AND CONTROL DEVICE FOR HEAD-MOUNTED DISPLAY APPARATUS, ELECTRONIC APPARATUS AND STORAGE MEDIUM”, filed with the China Patent Office on Sep. 29, 2022, the entire contents of which are incorporated by reference in this application.

### TECHNICAL FIELD

The present disclosure relates to a technical field of head-mounted display apparatuses, and in particular, to a control method and a control device for a head-mounted display apparatus, an electronic apparatus and a computer-readable storage medium.

### BACKGROUND

At present, in order to improve the display effect, for head-mounted display apparatuses such as AR (Augmented Reality) apparatuses and MR (Mix Reality) apparatuses, a dark light-shielding sheet is generally added which is outside and in front of the display lens. However, when the content is not needed to be displayed, the dark light-shielding sheet will affect the user's observation of the real world. With the emergence of color-changing materials, this problem can be well solved.

Therefore, it is a problem that needs to be solved urgently how to provide a color-changing and transparent strategy for a light-shielding sheet to achieve automatic color change of the light-shielding sheet in the head-mounted display apparatus and improve the user's experience.

### SUMMARY

A purpose of the present disclosure is to provide a control method and a control device for a head-mounted display apparatus, an electronic apparatus and a computer-readable storage medium, so as to utilize the interaction between the apparatuses to trigger the color change of the light-shielding sheet and improve the user's experience.

In order to solve the above technical problem, the present disclosure provides a control method for a head-mounted display apparatus, including:
obtaining distance information between the head-mounted display apparatus and a target apparatus, wherein the head-mounted display apparatus is wirelessly connected to the target apparatus;
detecting an interaction behavior between the head-mounted display apparatus and the target apparatus according to the distance information; and
adjusting a color of a light-shielding sheet of the head-mounted display apparatus according to the interaction behavior.

Optionally, the detecting the interaction behavior between the head-mounted display apparatus and the target apparatus according to the distance information includes:
detecting the interaction behavior according to the distance information and posture data, wherein the posture data includes first motion state information collected by a motion sensor of the head-mounted display apparatus and/or second motion state information collected by a motion sensor of the target apparatus.

Optionally, the detecting the interaction behavior according to the distance information and the posture data includes:
determining, by the head-mounted display apparatus, whether the distance information is within a response distance range;
if so, sending the collected first motion state information to the target apparatus, and receiving the second motion state information sent by the target apparatus; and
detecting the interaction behavior according to a change in the distance information within the response distance range, the first motion state information and the second motion state information.

Optionally, the obtaining the distance information between the head-mounted display apparatus and the target apparatus includes:
obtaining, by the head-mounted display apparatus, the distance information according to an intensity of a wireless signal connected to the target apparatus.

Optionally, the adjusting the color of the light-shielding sheet of the head-mounted display apparatus according to the interaction behavior includes:
if the interaction behavior is an approaching behavior, adjusting the color of the light-shielding sheet of the head-mounted display apparatus to be lighter, and controlling a screen of the target apparatus to be turned on.

Optionally, before the adjusting the color of the light-shielding sheet of the head-mounted display apparatus according to the interaction behavior, the method further includes:
determining a master apparatus according to a first motion state information and a second motion state information corresponding to the interaction behavior; wherein the master apparatus is the head-mounted display apparatus or the target apparatus, the first motion state information is motion state information collected by a motion sensor of the head-mounted display apparatus, and the second motion state information is the motion state information collected by a motion sensor of the target apparatus, and
wherein correspondingly, the adjusting the color of the light-shielding sheet of the head-mounted display apparatus according to the interaction behavior includes:
adjusting the color of the light-shielding sheet of the head-mounted display apparatus using the master apparatus.

Optionally, the determining the master apparatus according to the first motion state information and the second motion state information corresponding to the interaction behavior includes:
if the first motion state information corresponding to the interaction behavior is in a motion state, and the second motion state information corresponding to the interaction behavior is in a stationary state, determining the head-mounted display apparatus as the master apparatus;
if the first motion state information corresponding to the interaction behavior is in the stationary state, and the second motion state information corresponding to the interaction behavior is in the motion state, determining the target apparatus as the master apparatus; and
when the first motion state information and the second motion state information corresponding to the interaction behavior are both in the motion state, if an acceleration corresponding to the first motion state information is greater than an acceleration corresponding to the second motion state information, determining the head-mounted display apparatus as the master apparatus, and if the acceleration corresponding to the first motion state information is not greater than the acceleration corresponding to the second motion state information, determining the target apparatus as the master apparatus.

The present disclosure further provides a control device for a head-mounted display apparatus, the control device including:
an acquisition module configured to obtain distance information between the head-mounted display apparatus and a target apparatus, wherein the head-mounted display apparatus is wirelessly connected to the target apparatus;
a detection module configured to detect an interaction behavior between the head-mounted display apparatus and the target apparatus according to the distance information; and
a control module configured to adjust a color of a light-shielding sheet of the head-mounted display apparatus according to the interaction behavior.

The present disclosure further provides an electronic apparatus, including:
a memory configured to store a computer program; and
a processor configured to implement steps of the control method for the head-mounted display apparatus as described above when executing the computer program.

The present disclosure further provides a computer-readable storage medium, wherein a computer program is stored on the computer-readable storage medium, and when the computer program is executed by a processor, steps of the control method for the head-mounted display apparatus as described above are implemented.

The present disclosure provides a control method for a head-mounted display apparatus, including: obtaining distance information between the head-mounted display apparatus and a target apparatus, wherein the head-mounted display apparatus is wirelessly connected to the target apparatus; detecting an interaction behavior between the head-mounted display apparatus and the target apparatus according to the distance information; and adjusting a color of a light-shielding sheet of the head-mounted display apparatus according to the interaction behavior.

It can be seen that the present disclosure utilizes the distance information between the head-mounted display apparatus and the target apparatus to detect the interaction behavior between the apparatuses, so that the color of the light-shielding sheet of the head-mounted display apparatus can be adjusted according to the interaction behavior to achieve the interactive control of the apparatus status, thereby triggering an automatic color change of the light-shielding sheet of the head-mounted display apparatus by the interaction between the apparatuses, and improving the user's experience. In addition, the present disclosure also provides a control device for a head-mounted display apparatus, an electronic apparatus, and a computer-readable storage medium.

### BRIEF DESCRIPTION OF DRAWINGS

In order to more clearly illustrate the embodiments of the present disclosure or the technical solutions in the related art, the drawings required for use in the description of the embodiments or the related art will be briefly introduced below. Obviously, the drawings described below are merely embodiments of the present disclosure. For those skilled in the art, other drawings can be obtained based on the provided drawings without paying any creative work.

FIG. 1 is a flow chart of a control method of a head-mounted display apparatus provided in an embodiment of the present disclosure;

FIG. 2 is a schematic diagram of the switching of the apparatus status of another control method of a head-mounted display apparatus provided in an embodiment of the present disclosure; and

FIG. 3 is a structural block diagram of a control device for a head-mounted display apparatus provided in an embodiment of the present disclosure.

### DETAILED DESCRIPTIONS

In order to make the purpose, technical solution and advantages of the embodiments of the present disclosure clearer, the technical solution in the embodiments of the present disclosure will be clearly and completely described below in conjunction with the drawings in the embodiments of the present disclosure. Obviously, the described embodiments are part of the embodiments of the present disclosure, not all of the embodiments. Based on the embodiments in the present disclosure, all other embodiments obtained by those skilled in the art without creative work are within the protection scope of the present disclosure.

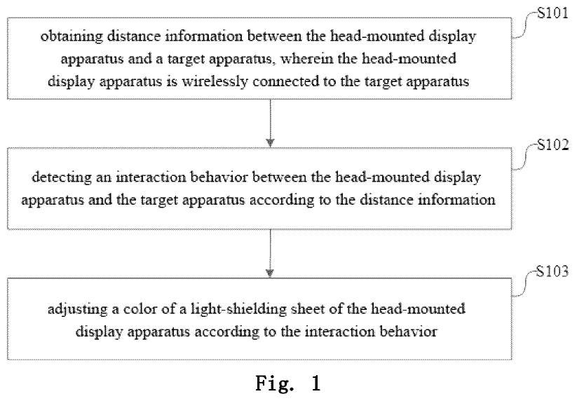

Please refer to FIG. 1, which is a flow chart of a control method of a head-mounted display apparatus provided in an embodiment of the present disclosure. The method includes:

Step 101: obtaining distance information between the head-mounted display apparatus and a target apparatus, wherein the head-mounted display apparatus is wirelessly connected to the target apparatus.

It can be understood that the target apparatus in this embodiment may be any electronic apparatus used for interactive control with the head-mounted display apparatus, such as wearable apparatuses (such as smart watches and smart bracelets, etc.) and mobile terminal apparatuses (such as smart phones), etc. The target apparatus may be wirelessly connected to the head-mounted display apparatus, such as Bluetooth connection, Wi-Fi connection or infrared connection, etc.

Specifically, the control method for the head-mounted display apparatus provided in this embodiment may be applied to the head-mounted display apparatus, that is, the processor of the head-mounted display apparatus may execute the steps of the method provided in this embodiment, detect the interaction behavior between the head-mounted display apparatus and the target apparatus, and adjust the color of the light-shielding sheet of the head-mounted display apparatus; the control method for the head-mounted display apparatus provided in this embodiment may be applied to the target apparatus or a terminal apparatus (such as a cloud server) connected to the head-mounted display apparatus and the target apparatus, and this embodiment does not have any restrictions thereon.

Specifically, the distance information in this step may be information on the distance between the head-mounted display apparatus and the target apparatus. The specific method for obtaining the distance information between the head-mounted display apparatus and the target apparatus by the processor in this step may be set by the designer himself according to practical scenarios and user requirements. For example, the processor may obtain the distance information according to the intensity of the wireless signal connecting the head-mounted display apparatus and the target apparatus. For instance, the processor of the head-mounted display apparatus may detect the distance information from the target apparatus using the RSSI (Received Signal Intensity Indication) value of the Bluetooth connection with the target apparatus. The processor may also obtain the distance information based on the sensor data of the distance measuring sensors (such as ultrasonic distance measuring sensors or optical distance measuring sensors) in the head-mounted display apparatus and the target apparatus. For example, the head-mounted display apparatus may detect the distance information from the target apparatus using the ultrasonic signal output by the ultrasonic generator in the target apparatus collected by its own ultrasonic receiver (i.e., an ultrasonic distance measuring sensor). As long as the processor can obtain the distance information between the head-mounted display apparatus and the target apparatus, this embodiment does not have any restrictions thereon.

Step 102: detecting the interaction behavior between the head-mounted display apparatus and the target apparatus according to the distance information.

It may be understood that the interaction behavior in this step may be a preset behavior corresponding to a change in the distance between the head-mounted display apparatus and the target apparatus. The specific number and type of the interaction behavior in this step may be set by the designer himself according to practical scenarios and user needs. For example, the interaction behavior may include an approaching behavior corresponding to a reduction in the distance between the head-mounted display apparatus and the target apparatus; the interaction behavior may also include a contact behavior corresponding to a reduction in the distance to be contacted between the head-mounted display apparatus and the target apparatus; and the interaction behavior may also include a moving away behavior corresponding to an increase in the distance between the head-mounted display apparatus and the target apparatus.

Specifically, the specific method for detecting the interaction behavior between the head-mounted display apparatus and the target apparatus by the processor according to the distance information in this step may be set by the designer himself. For example, the processor may detect the interaction behavior between the head-mounted display apparatus and the target apparatus only by using the distance information. For example, the processor may detect the interaction behavior between the head-mounted display apparatus and the target apparatus according to the distance information within a response distance range (such as 0 cm to 60 cm). For instance, after detecting that the distance information within the response distance range has changed, if the distance information within the response distance range decreases to a response threshold (such as 2 cm) and the distance information is not 0 when the distance change stops, the processor determines that the interaction behavior is the approaching behavior; if the distance information within the response distance range decreases to the response threshold and the distance information is 0 when the distance change stops, it is determined that interaction behavior is the contact behavior; and if the distance information within the response distance range increases to the response threshold, it is determined that the interaction behavior is the moving away behavior.

Correspondingly, the processor may also detect the interaction behavior based on the distance information and posture data; wherein the posture data includes the first motion state information collected by the motion sensor (such as an accelerometer) of the head-mounted display apparatus and/or the second motion state information collected by the motion sensor of the target apparatus. That is to say, the processor may detect the interaction behavior between the head-mounted display apparatus and the target apparatus using the distance information and the posture data corresponding to the posture of the head-mounted display apparatus and/or the target apparatus. For example, the processor may detect the interaction behavior based on the distance information and posture data within the response distance range; for instance, the processor of the head-mounted display apparatus determines whether the distance information is within the response distance range; if so, the collected first motion state information is sent to the target apparatus (that is, the target apparatus may also detect the interaction behavior), and the second motion state information sent by the target apparatus is received; the interaction behavior is detected based on the change of the distance information within the response distance range, the first motion state information and the second motion state information.

Correspondingly, for the case that the distance information is not within the response distance range, it may be set by the designer himself. For example, the processor of the head-mounted display apparatus may directly end the process or return to the step 101 to continue to obtain the distance information when the distance information is not within the response distance range. This embodiment does not have any restrictions thereon.

It should be noted that the specific method for detecting the interaction behavior based on the change in the distance information within the response distance range, the first motion state information and the second motion state information may be set by the designer himself according to practical scenarios and user needs. For example, when the interaction behavior includes the approaching behavior, the processor may determine that the interaction behavior is the approaching behavior when it is detected that the distance information within the response distance range is reduced, and the distance information is not 0 after the first motion state information and the second motion state are both in the stationary state; determine that the interaction behavior is the contact behavior when it is detected that the distance information within the response distance range is reduced, and the distance information is 0 after the first motion state information and the second motion state are both in the stationary state; and determine that the interaction behavior is the moving away behavior when it is detected that the distance information of the response distance range is increased, and the first motion state information and the second motion state are both in the stationary state or the distance information exceeds the response distance range.

Correspondingly, the approaching behavior may be divided into a head-mounted display approaching behavior in which the head-mounted display apparatus actively approaches the target apparatus and a target behavior in which the target apparatus actively approaches the head-mounted display apparatus. For example, when the interaction behavior includes the head-mounted display approaching behavior and the target behavior, in a state that the processor detects that the distance information within the response distance range decreases and the distance information is not 0 when the distance change stops, if the first motion state information is in the motion state and the second motion state information is in the stationary state during the distance information decreases, the interaction behavior is determined to be the head-mounted display approaching behavior; if the first motion state information is in the stationary state and the second motion state information is in the motion state during the distance information decreases, the interaction behavior is determined to be the target approaching behavior; and if the first motion state information and the second motion state information are both in the motion state during the distance information decrease, when the acceleration corresponding to the first motion state information is greater than the acceleration (or speed) corresponding to the second motion state information, the interaction behavior is determined to be the head-mounted display approaching behavior, and when the acceleration corresponding to the first motion state information is not greater than the acceleration corresponding to the second motion state information, the interaction behavior is determined to be the target approaching behavior.

Specifically, the specific process of detecting the interaction behavior between the head-mounted display apparatus and the target apparatus based on the distance information by the processor in this embodiment may be set by the designer himself. For example, the processor may detect the interaction behavior between the head-mounted display apparatus and the target apparatus by itself using the distance information; for instance, the head-mounted display apparatus may detect the interaction behavior by itself based on the collected distance information and posture data. The processor may also detect the interaction behavior using other apparatuses by sending the distance information to other apparatuses (such as a cloud server) and receiving the interaction behavior returned by other apparatuses; for example, the head-mounted display apparatus may send the distance information and the posture data to the cloud server and receive the interaction behavior returned by the cloud server, to detect the interaction behavior using the cloud server. This embodiment does not have any restrictions thereon.

Step 103: adjusting the color of the light-shielding sheet of the head-mounted display apparatus according to the interaction behavior.

It may be understood that in this step, the processor may adjust the color of the light-shielding sheet of the head-mounted display apparatus according to the detected interaction behavior. For example, when the detected interaction behavior is the approaching behavior, the processor may control the head-mounted display apparatus to adjusting the color of the light-shielding sheet to be lighter, so that the user of the head-mounted display apparatus can better view the approaching target apparatus (such as a smart watch), thereby realizing automatic color change of the light-shielding sheet of the head-mounted display apparatus.

Specifically, in this step, the processor may also control the target apparatus to perform corresponding interactive operations according to the interaction behavior, that is, in this step, the processor may adjust the color of the light-shielding sheet of the head-mounted display apparatus according to the interaction behavior and control the target apparatus to perform corresponding interactive operations, thereby further improving the interaction effect between the head-mounted display apparatus and the target apparatus and enhancing the user's experience. For example, the processor may adjust the color of the light-shielding sheet of the head-mounted display apparatus to be lighter and control a screen of the target apparatus to be turned on when the interaction behavior is the approaching behavior.

Correspondingly, the specific process of adjusting the color of the light-shielding sheet of the head-mounted display apparatus according to the interaction behavior by the processor in this step may be set by the designer himself according to the practical scenario and user needs. For example, when the method provided in this embodiment is applied to the head-mounted display apparatus, the processor of the head-mounted display apparatus may directly adjust the color of the light-shielding sheet of the head-mounted display apparatus according to the interaction behavior, or adjust the color of the light-shielding sheet of the head-mounted display apparatus and control the target apparatus to perform the corresponding interactive operation. When the method provided in this embodiment is applied to the target apparatus, the processor of the target apparatus may directly control the head-mounted display apparatus to adjust the color of the light-shielding sheet according to the interaction behavior, or control the head-mounted display apparatus to adjust the color of the light-shielding sheet and control itself to perform the corresponding interactive operation. When the method provided in this embodiment is applied to the cloud server, the processor of the cloud server may directly control the head-mounted display apparatus to adjust the color of the light-shielding sheet according to the interaction behavior, or control the head-mounted display apparatus to adjust the color of the light-shielding sheet and control the target apparatus to perform the corresponding interactive operation. For example, when the processor of the head-mounted display apparatus detects that the interaction behavior is the approaching behavior, it can adjust the color of its own light-shielding sheet to be lighter and control the target apparatus to perform the corresponding interactive operation (such as lighting the screen). In the case that the approaching behavior includes the head-mounted display approaching behavior and the target approaching behavior, the processor of the head-mounted display apparatus may adjust the color of its own light-shielding sheet to be lighter and control the target apparatus to perform a corresponding interactive operation (such as turning on the screen) when detecting that the interaction behavior is the head-mounted display approaching behavior; correspondingly, adjusting the color of its own light-shielding sheet to be lighter according to the color change control instruction sent by the target apparatus when detecting that the interaction behavior is the target approaching behavior.

Furthermore, before this step, the processor may determine the master apparatus according to the first motion state information and the second motion state information corresponding to the interaction behavior; wherein the master apparatus is the head-mounted display apparatus or the target apparatus, the first motion state information is the motion state information collected by the motion sensor of the head-mounted display apparatus, and the second motion state information is the motion state information collected by the motion sensor of the target apparatus. Accordingly, in this step, the master apparatus may be used to control the head-mounted display apparatus to adjust the color of the light-shielding sheet, or to control the head-mounted display apparatus to adjust the color of the light-shielding sheet and control the target apparatus to perform a corresponding interactive operation. That is to say, in this embodiment, the master apparatus among the head-mounted display apparatus and the target apparatus may be used to control the head-mounted display apparatus to adjust the color of the light-shielding sheet, or to control the head-mounted display apparatus to adjust the color of the light-shielding sheet and control the target apparatus to perform a corresponding interactive operation. For example, when the method provided in this embodiment is applied to the head-mounted display apparatus, if the processor of the head-mounted display apparatus determines that the master apparatus is the head-mounted display apparatus, then when the interaction behavior is detected as the approaching behavior, the processor may adjust the color of its own light-shielding sheet to be lighter, and control the target apparatus to perform the corresponding interactive operation; if the master apparatus is determined to be the target apparatus, then when the interaction behavior is detected as the approaching behavior, the processor may adjust the color of its own light-shielding sheet to be lighter according to the color change control instruction sent by the target apparatus; that is, when the target apparatus determines that the master apparatus is itself and the interaction behavior is the approaching behavior, the target apparatus may send the color change control instruction to the head-mounted display apparatus, so that the head-mounted display apparatus adjusts the color of its light-shielding sheet to be lighter.

Specifically, the specific method for determining the master apparatus according to the first motion state information and the second motion state information corresponding to the interaction behavior may be set by the designer himself. For example, the processor may determine the head-mounted display apparatus as the master apparatus when the first motion state information corresponding to the interaction behavior is in the motion state and the second motion state information corresponding to the interaction behavior is in the stationary state; determine the target apparatus as the master apparatus when the first motion state information corresponding to the interaction behavior is in the stationary state and the second motion state information corresponding to the interaction behavior is in the motion state; and when the first motion state information and the second motion state information corresponding to the interaction behavior are both in the motion state, if the acceleration corresponding to the first motion state information is greater than the acceleration corresponding to the second motion state information, determine the head-mounted display apparatus as the master apparatus, and if the acceleration corresponding to the first motion state information is not greater than the acceleration corresponding to the second motion state information, determine the target apparatus as the master apparatus.

For example, after the distance information between the head-mounted display apparatus and the target apparatus enters the response distance range, the head-mounted display apparatus and the target apparatus may be quickly connected and exchange data (such as the first motion state information and the second motion state information); if during the approaching behavior, the first motion state information is in the motion state (that is, the head-mounted display apparatus is moving), and the second motion state information is in the stationary state (that is, the target apparatus is stationary), it can be determined that the head-mounted display apparatus actively approaches the target apparatus, thereby determining that the head-mounted display apparatus is the master apparatus; if during the approaching behavior, the first motion state information is in the stationary state, and the second motion state information is in the motion state, it can be determined that the target apparatus actively approaches the head-mounted display apparatus, thereby determining that the target apparatus is the master apparatus; and during the approaching behavior, when both the first motion state information and the second motion state information are in the motion state, if the motion speed or the motion acceleration of the head-mounted display apparatus is greater than that of the target apparatus, the head-mounted display apparatus is confirmed to be the master apparatus, otherwise, the target apparatus is confirmed to be the master apparatus.

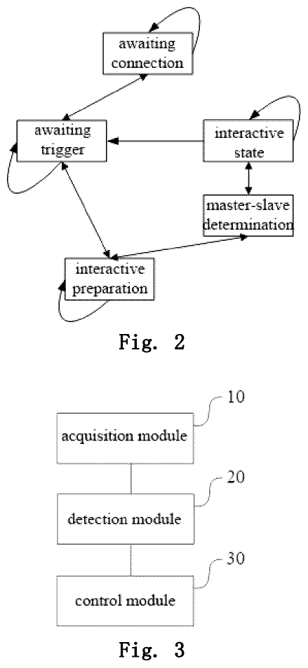

Correspondingly, the switching process of the internal state of the head-mounted display apparatus and/or the target apparatus may be as shown in FIG. 2, wherein an awaiting connection state may be a state entered after the apparatus system is started and the application is started; an awaiting trigger state may be a state in which the apparatus establishes a physical connection (i.e., a wireless communication connection between the head-mounted display apparatus and the target apparatus) through WiFi or Bluetooth, the application creates a connection link, and mutually sends messages to maintain smooth communication with each other, and waits for a trigger message; an interactive preparation state may be a state in which the apparatus detects a predetermined trigger state, such as a distance within the response distance range or the motion state information in a preset trigger posture (e.g., a motion state), sending an interactive preparation message to the other party. After entering the interactive preparation state, a data channel may be established between the apparatuses. The master-slave determination state may be a state in which the master-slave relationship (i.e., a master apparatus and a slave apparatus) is confirmed according to the distance information change and the posture data between the apparatuses; and the interactive state may be a state in which data is interacted between the apparatuses, such as the transmission of control instructions for interactive operations (e.g., color change control instructions).

Specifically, the specific settings of the interactive operations performed by the above-mentioned target apparatuses may be set by the designer himself according to practical scenarios and user needs. For example, the interactive operations may include screen-on and screen-off operations. For example, in this step, if the head-mounted display apparatus detects that the interaction behavior is the approaching behavior, the color of the light-shielding sheet may be lighter, and the target apparatus (such as a wearable apparatus) may be controlled to turn on the screen; if the head-mounted display apparatus detects that the interaction behavior is a moving away behavior, the color of the light-shielding sheet may be darkened, and the target apparatus may be controlled to turn off the screen. The interactive operation may also include the display operation of the target information. For example, when the head-mounted display apparatus detects that the interaction behavior is the approaching behavior, it can also send target information (such as time information) to the target apparatus and control the target apparatus to display the target information. The interactive operation may also include the start-up operation of a specific function of the target apparatus, such as the start-up operation of the heart rate and body temperature monitoring functions etc. of the smart bracelet.

Furthermore, in this step, the processor may also control the head-mounted display apparatus to perform other interactive operations in addition to adjusting the color of the light-shielding sheet according to the interaction behavior, such as start and stop control operations of music playback. For example, when the interaction behavior is the contact behavior, the processor may control the head-mounted display apparatus to maintain the color of the light-shielding sheet unchanged, and switch the start and stop of music playback or terminate the call.

Correspondingly, in this embodiment, the interactive operations corresponding to the same interaction behavior when the master apparatuses are different may be the same. For example, the interactive operations corresponding to the approaching behavior of the head-mounted display apparatus actively approaching the target apparatus and the approaching behavior of the target apparatus actively approaching the head-mounted display apparatus may be the same. For instance, both are the operation for adjusting the color of the light-shielding-sheet of the head-mounted display apparatus to be lighter and the screen-on operation of the target apparatus. The interactive operations corresponding to the same interaction behavior when the master apparatuses are different may also be different. For example, when the master apparatus is the head-mounted display apparatus, the interactive operation corresponding to the approaching behavior (i.e., the head display approaching behavior) may be the operation for adjusting the light-shielding-sheet of the head-mounted display apparatus to be lighter and the screen-on operation of the target apparatus, so that when the user lowers his head to view the target apparatus, the color of the light-shielding sheet may be adjusted to be lighter and the screen of the target apparatus is turned on at the same time, thereby improving the user's experience. When the master apparatus is the target apparatus, the interactive operation corresponding to the approaching behavior (i.e., the target approaching behavior) may be the operation for adjusting the color the light-shielding-sheet of the head-mounted display apparatus to be lighter, so that the user can adjust the light-shielding sheet to be lighter by moving the target apparatus approaching, thereby facilitating viewing of the external environment. This embodiment does not have any restrictions thereon.

In this embodiment, the embodiment of the present disclosure utilizes the distance information between the head-mounted display apparatus and the target apparatus to detect the interaction behavior between the apparatuses, so that the color of the light-shielding sheet of the head-mounted display apparatus can be controlled according to the interaction behavior to achieve interactive control of the apparatus status, thereby triggering the automatic color change of the light-shielding sheet of the head-mounted display apparatus through the interaction between the apparatuses, and improving the user experience.

Corresponding to the above method embodiment, an embodiment of the present disclosure further provides a control device for a head-mounted display apparatus. The control device for the head-mounted display apparatus described below and the control method for a head-mounted display apparatus described above can refer to each other.

Please refer to FIG. 3, which is a structural block diagram of a control device for a head-mounted display apparatus provided in an embodiment of the present disclosure. The device may include:
an acquisition module 10 configured to obtain the distance information between the head-mounted display apparatus and the target apparatus, wherein the head-mounted display apparatus is wirelessly connected to the target apparatus;
a detection module 20 configured to detect the interaction behavior between the head-mounted display apparatus and the target apparatus according to the distance information; and
a control module 30 configured to adjust the color of the light-shielding sheet of the head-mounted display apparatus according to the interaction behavior.

Optionally, the detection module 20 may be specifically configured to detect interaction behavior based on distance information and posture data, wherein the posture data includes first motion state information collected by a motion sensor of the head-mounted display apparatus and/or second motion state information collected by a motion sensor of the target apparatus.

Optionally, when the control device is applied to the head-mounted display apparatus, the detection module 20 may include:
a determination submodule configured to determine whether the distance information is within the response distance range;
a transceiver submodule configured to send the collected first motion state information to the target apparatus if it is within the response distance range, and receive the second motion state information sent by the target apparatus; and
a detection submodule configured to detect the interaction behavior according to the change in the distance information within the response distance range, the first motion state information and the second motion state information.

Optionally, when the control device is applied to a head-mounted display apparatus, the acquisition module 10 may be specifically configured to obtain distance information according to the intensity of a wireless signal connected to the target apparatus.

Optionally, the control module 30 may include:
an approach control submodule configured to adjust the color of the light-shielding sheet of the head-mounted display apparatus to be lighter and control a screen of the target apparatus to be turned on if the interaction behavior is an approaching behavior.

Optionally, the control device may further include:
a master-slave determination module configured to determine the master apparatus according to the first motion state information and second motion state information corresponding to the interaction behavior; wherein the master apparatus is the head-mounted display apparatus or the target apparatus, the first motion state information is motion state information collected by a motion sensor of the head-mounted display apparatus, and the second motion state information is motion state information collected by a motion sensor of the target apparatus;

Correspondingly, the control module 30 may be specifically configured to control the color of the light-shielding sheet of the head-mounted display apparatus using the master apparatus.

Optionally, the master-slave determination module may include:
a first determination submodule configured to determine the head-mounted display apparatus as a master apparatus if the first motion state information corresponding to the interaction behavior is in a motion state and the second motion state information corresponding to the interaction behavior is in a stationary state;
a second determination submodule configured to determine the target apparatus as a master apparatus if the first motion state information corresponding to the interaction behavior is in the stationary state and the second motion state information corresponding to the interaction behavior is in the motion state;
a third determination submodule configured to determine the head-mounted display apparatus as the master apparatus if the acceleration corresponding to the first motion state information is greater than an acceleration corresponding to the second motion state information, and determine the target apparatus as the master apparatus if the acceleration corresponding to the first motion state information is not greater than the acceleration corresponding to the second motion state information, in a state that the acceleration corresponding to the first motion state information and the second motion state information corresponding to the interaction behavior are both in a motion state.

In this embodiment, the embodiment of the present disclosure uses the distance information between the head-mounted display apparatus and the target apparatus through the detection module 20 to detect the interaction behavior between the apparatuses, so that the control module 30 may adjust the color of the light-shielding sheet of the head-mounted display apparatus according to the interaction behavior to achieve interactive control of the apparatus status, thereby triggering the automatic color change of the light-shielding sheet of the head-mounted display apparatus through the interaction between the apparatuses, and improving the user experience.

Corresponding to the above method embodiment, an embodiment of the present disclosure further provides an electronic apparatus. The electronic apparatus described below and the control method for the head-mounted display apparatus described above can refer to each other.

An electronic apparatus, including:
a memory configured to store a computer program;
a processor configured to implement steps of the control method for the head-mounted display apparatus as described above when executing the computer program.

Specifically, this embodiment does not limit the specific apparatus type of the electronic apparatus. The electronic apparatus provided in this embodiment may be a head-mounted display apparatus, such as AR glasses; or it may be a target apparatus wirelessly connected to the head-mounted display apparatus, such as a wearable apparatus (such as a smart watch and a smart bracelet).

Corresponding to the above method embodiment, an embodiment of the present disclosure further provides a computer-readable storage medium. The computer-readable storage medium described below and the control method for a head-mounted display apparatus described above can refer to each other.

A computer-readable storage medium stores a computer program, wherein the computer program, when executed by a processor, implements the steps of the method for controlling a head-mounted display apparatus provided in the above method embodiment.

The computer-readable storage medium may specifically be a medium, such as a USB flash drive, a mobile hard disk, a read-only memory (ROM), a random access memory (RAM), a magnetic disk, or an optical disk, etc., which may store program codes.

The various embodiments in the specification are described in a progressive manner, and each embodiment focuses on the differences from other embodiments. The same or similar parts between the various embodiments can be referred to each other. For the control device, the electronic apparatus and the computer-readable storage medium disclosed in the embodiment, since they correspond to the method disclosed in the embodiment, the description is relatively simple, and the relevant parts can be referred to the method part description.

The above is a detailed introduction to a control method, a control device, an electronic apparatus and a computer-readable storage medium for a head-mounted display apparatus provided by the present disclosure. This article uses specific examples to illustrate the principles and implementation methods of the present disclosure. The description of the above embodiments is only used to help understand the method for the present disclosure and its core idea. It should be pointed out that for ordinary technicians in this technical field, without departing from the principles of the present disclosure, several improvements and modifications can be made to the present disclosure, and these improvements and modifications also fall within the scope of protection of the claims of the present disclosure.

1. A control method for a head-mounted display apparatus, comprising:
obtaining distance information between the head-mounted display apparatus and a target apparatus, wherein the head-mounted display apparatus is wirelessly connected to the target apparatus;
detecting an interaction behavior between the head-mounted display apparatus and the target apparatus according to the distance information; and
adjusting a color of a light-shielding sheet of the head-mounted display apparatus according to the interaction behavior ..

2. The control method for the head-mounted display apparatus according to claim 1, wherein the detecting the interaction behavior between the head-mounted display apparatus and the target apparatus according to the distance information comprises:
detecting the interaction behavior according to the distance information and posture data, wherein the posture data comprises first motion state information collected by a motion sensor of the head-mounted display apparatus and/or second motion state information collected by a motion sensor of the target apparatus.

3. The control method for the head-mounted display apparatus according to claim 2, wherein the detecting the interaction behavior according to the distance information and the posture data comprises:
determining, by the head-mounted display apparatus, whether the distance information is within a response distance range;
if so, sending the collected first motion state information to the target apparatus, and receiving the second motion state information sent by the target apparatus; and
detecting the interaction behavior according to a change in the distance information within the response distance range, the first motion state information and the second motion state information.

4. The control method for the head-mounted display apparatus according to claim 1, wherein the obtaining the distance information between the head-mounted display apparatus and the target apparatus comprises:
obtaining, by the head-mounted display apparatus, the distance information according to an intensity of a wireless signal connected to the target apparatus.

5. The control method for the head-mounted display apparatus according to claim 1, wherein the adjusting the color of the light-shielding sheet of the head-mounted display apparatus according to the interaction behavior comprises:
if the interaction behavior is an approaching behavior, adjusting the color of the light-shielding sheet of the head-mounted display apparatus to be lighter, and controlling a screen of the target apparatus to be turned on.

6. The control method for the head-mounted display apparatus according to claim 1, wherein before the adjusting the color of the light-shielding sheet of the head-mounted display apparatus according to the interaction behavior, the method further comprises:
determining a master apparatus according to a first motion state information and a second motion state information corresponding to the interaction behavior, wherein the master apparatus is the head-mounted display apparatus or the target apparatus, the first motion state information is motion state information collected by a motion sensor of the head-mounted display apparatus, and the second motion state information is motion state information collected by a motion sensor of the target apparatus, and
wherein correspondingly, the adjusting the color of the light-shielding sheet of the head-mounted display apparatus according to the interaction behavior comprises:
adjusting the color of the light-shielding sheet of the head-mounted display apparatus using the master apparatus.

7. The control method for the head-mounted display apparatus according to claim 6, wherein the determining the master apparatus according to the first motion state information and the second motion state information corresponding to the interaction behavior comprises:
if the first motion state information corresponding to the interaction behavior is in a motion state, and the second motion state information corresponding to the interaction behavior is in a stationary state, determining the head-mounted display apparatus as the master apparatus;
if the first motion state information corresponding to the interaction behavior is in the stationary state, and the second motion state information corresponding to the interaction behavior is in the motion state, determining the target apparatus as the master apparatus; and
when the first motion state information and the second motion state information corresponding to the interaction behavior are both in the motion state, if an acceleration corresponding to the first motion state information is greater than an acceleration corresponding to the second motion state information, determining the head-mounted display apparatus as the master apparatus, and if the acceleration corresponding to the first motion state information is not greater than the acceleration corresponding to the second motion state information, determining the target apparatus as the master apparatus.

8. A control device for a head-mounted display apparatus, the control device comprising:
an acquisition module configured to obtain distance information between the head-mounted display apparatus and a target apparatus, wherein the head-mounted display apparatus is wirelessly connected to the target apparatus;
a detection module configured to detect an interaction behavior between the head-mounted display apparatus and the target apparatus according to the distance information; and
a control module configured to adjust a color of a light-shielding sheet of the head-mounted display apparatus according to the interaction behavior.

9. An electronic apparatus, comprising:
a memory configured to store a computer program; and
a processor configured to implement steps of the control method for the head-mounted display apparatus according to claim 1 when executing the computer program.

10. A computer-readable storage medium, wherein a computer program is stored on the computer-readable storage medium, and when the computer program is executed by a processor, steps of the control method for the head-mounted display apparatus according to claim 1 are implemented.
